(19) United States
(12) Patent Application Publication
(10) Pub. No.: US 2006/0158153 A1
(43) Pub. Date: Jul. 20, 2006

(54) Current adapting and rechargeable device

(75) Inventor: Jung-Wen Chang, Lu Chu Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/247,347

(22) Filed: Oct. 11, 2005

(30) Foreign Application Priority Data
Jan. 17, 2005 (TW) 94200860

(51) Int. Cl. H02J 7/00

(52) U.S. Cl. 320/107

(57) ABSTRACT

A current adapting and rechargeable device is provided. The current adapting and rechargeable device includes a rechargeable unit, a current adapting unit and a charging circuit. The current adapting unit is for receiving a first current from a power source and outputting a second current accordingly. The charging circuit is electrically connected to the rechargeable unit and the current adapting unit, respectively. The charging circuit is for receiving and utilizing the second current to charge the rechargeable unit when the charge of the rechargeable unit is not full.

This application claims the benefit of Taiwan application Serial No. 94200860, filed Jan. 17, 2005, the subject matter of which is incorporated herein by reference.

### BACKGROUND OF THE INVENTION

1. Field of the Invention

The invention relates in general to a battery, and more particularly to a current adapting and rechargeable device with both adaptor and battery function.

2. Description of the Related Art

Living in today's society where science and technology advance rapidly, computer has become an indispensable part in modern people's everyday life. In particularity, notebook computer, with the features of slimness, compactness, lightweight, and portability, has won a great popularity.

Conventional chamber of the notebook computer has a battery disposed therein. The battery is separable from the chamber of the notebook computer. When the notebook computer is not connected to any external power source, the battery carrying charges serves as an internal power source to provide the notebook computer with necessary power, however, the duration of the battery is limited. When the battery is flat and needs to be charged, the battery disposed in the chamber of the notebook computer needs to be charged by an external power source via an external current adapting unit.

Since the external current adapting unit is not fixed to the battery and the duration of the battery is limited, when the user goes out with a notebook computer, the user must not forget to bring an external current adapting unit. If the user should forget to bring the external current adapting unit, the battery can not be charged when flat, and the user can only use the notebook computer within the duration of the battery, causing severe inconvenience. Likewise, other portable electronic devices, such as personal digital assistant or mobile phone for instance, would face the same problems if the external current adapting unit is not fixed to the battery and the duration of the battery is limited.

### SUMMARY OF THE INVENTION

It is therefore the object of the invention to provide a current adapting and rechargeable device. The design of having both adaptor and battery function brings about convenience in terms of portability and use, saving the trouble of bringing an external current adapting unit with a conventional portable electronic device. Thus, the problem arising when the user forgets to bring the external current adapting unit with which a flat battery could not be charged can be avoided. In addition, the current adapting and rechargeable device of the invention can be connected to the external power source via a commonly used power line, and can be connected to the external power source to be charged alone without going with the portable electronic device.

According to an object of the invention, a current adapting and rechargeable device including a rechargeable unit, a current adapting unit and a charging circuit is provided. The current adapting unit is for receiving a first current from an external power source and outputting a second current accordingly. The charging circuit is electrically connected to the rechargeable unit and the current adapting unit, respectively. When the charge of the rechargeable unit is not full, the charging circuit receives and utilizes the second current to charge the rechargeable unit.

According to another object of the invention, a portable electronic device including a current adapting and rechargeable device and a power connecting module is provided. The current adapting and rechargeable device includes a rechargeable unit, a current adapting unit and a charging circuit. The current adapting unit is for receiving a first current from an external power source and outputting a second current accordingly. The charging circuit is electrically connected to the rechargeable unit and the current adapting unit, respectively. When the charge of the rechargeable unit is not full, the charging circuit receives and utilizes the second current to charge the rechargeable unit. The power connecting module is electrically connected to the rechargeable unit, and is electrically connected to the external power source via the current adapting and rechargeable device.

In addition, the charging circuit determines whether the charge of the rechargeable unit is full when the second current is received by the charging circuit. When the charging circuit determines that the charge of the rechargeable unit is not full, the charging circuit utilizes the second current to charge the rechargeable unit.

When the charging circuit determines that the charge of the rechargeable unit is full, the charging circuit does not charge the rechargeable unit. Meanwhile, the second current is transmitted form the charging circuit to the power connecting module and bypasses the rechargeable unit. Alternatively, the second current is transmitted from the current adapting unit to the power connecting module and bypasses the charge circuit and the rechargeable unit.

When the current adapting and rechargeable device is electrically connected to the external power source, the charging circuit transmits the second current to the power connecting module via the rechargeable unit no matter the charge of the rechargeable unit is full or not.

When the current adapting unit does not receive the first current and the rechargeable unit still has charges, the rechargeable unit provides power to the power connecting module.

The first current and the second current are an alternating current (AC) and a direct current (DC), respectively. The external power source is an electric supply.

The current adapting and rechargeable device of the invention can be a battery with adaptor function, an adaptor with battery function, or a portable device with both adaptor and battery function.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a current adapting and rechargeable device according to a preferred embodiment of the invention;

FIG. 2 is a block diagram showing the current adapting and rechargeable device of FIG. 1 which is disposed in a portable electronic device and separated from an external power source; and

FIG. 3 is a block diagram showing the current adapting and rechargeable device of FIG. 2 which is connected to an external power source.

### DETAILED DESCRIPTION OF THE INVENTION

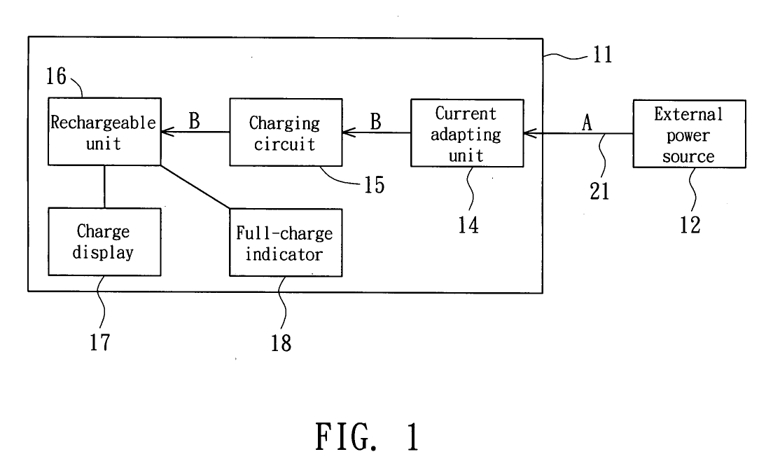

Referring to FIG. 1, a block diagram of a current adapting and rechargeable device according to a preferred embodiment of the invention is shown. In FIG. 1, a current adapting and rechargeable device 11 includes a rechargeable unit 16, a current adapting unit 14 and a charging circuit 15. The current adapting unit 14 is for receiving a first current A from an external power source 12 and outputting a second current B accordingly. In addition, the current adapting unit 14 can receive the first current A via a power line 21 for instance, the first current A and the second current B respectively are an alternating current (AC) and a direct current (DC) for instance, and the external power source 12 is an electric supply for instance. Besides, the power line 21 can be fixed to the current adapting unit 14 for the power line 21 to be incorporated with the current adapting and rechargeable device 11.

The charging circuit 15 is electrically connected to the current adapting unit 14 and the rechargeable unit 16, respectively. The charging circuit 15 is for receiving the second current B and determining whether the charge of the rechargeable unit 16 is full or achieves a predetermined level to decide whether to utilize the second current B to charge the rechargeable unit 16 or not. In the present embodiment of the invention, the charging circuit 15 is exemplified by determining whether the charge of the rechargeable unit 16 is full or not. When the charging circuit 15 determines that the charge of the rechargeable unit 16 is not full, the charging circuit 15 utilizes the second current B to charge the rechargeable unit 16. When the charging circuit 14 determines that the charge of the rechargeable unit 16 is full, the charging circuit 15 does not need to utilize the second current B to charge the rechargeable unit 16.

However, anyone who is skilled in the technology of the present embodiment of the invention will understand that the scope of technology of the present embodiment of the invention is not limited thereto. For example, the current adapting and rechargeable device 11 further includes a charge display 17 electrically connected to the rechargeable unit 16 for displaying the charge level of the rechargeable unit 16. In addition, the current adapting and rechargeable device 11 further includes a full-charge indicator 18 electrically connected to the rechargeable unit 16 for providing a ray of light or a sound to inform the user when the rechargeable unit 16 has been fully charged by the charging circuit 15. Besides, the full-charge indicator 18 is a light bulb, a light emitting diode (LED), a beeper or a speaker for instance. The abovementioned rechargeable unit 16 is a battery in the present embodiment of the invention.

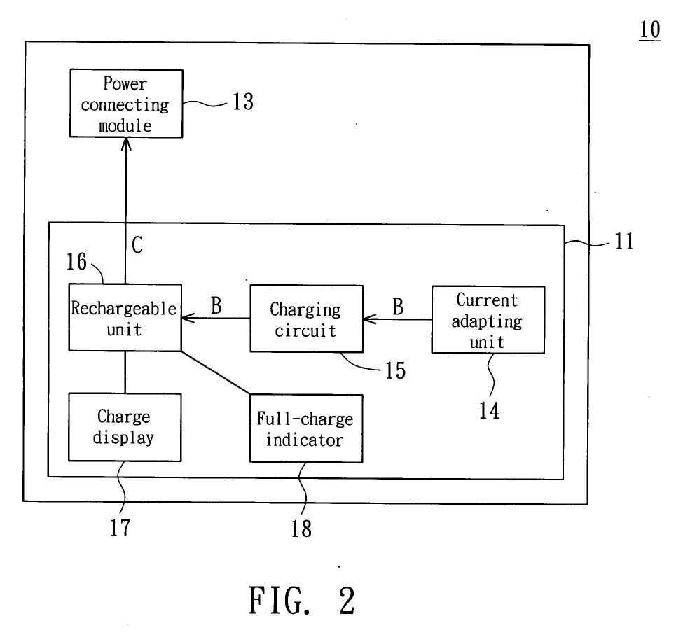

Referring to FIG. 2, a block diagram showing the current adapting and rechargeable device of FIG. 1, which is disposed in a portable electronic device and separated from an external power source, is shown. In FIG. 2, the current adapting and rechargeable device 11 can be built-in or pluggable to be disposed in the chamber of a portable electronic device 10, and the power line 21 can be rolled up to be stored in the chamber of the portable electronic device 10. Alternatively, the current adapting and rechargeable device 11 is electrically connected to the portable electronic device 10 via another power line. The portable electronic device 10 can be a notebook computer, a personal digital assistant (PDA) or a mobile phone for instance.

The portable electronic device 10 has a power connecting module 13 electrically connected to the rechargeable unit 16 and other parts inside the portable electronic device 10. In addition, the rechargeable unit 16 has a first electric terminal, and the power connecting module 13 has a second electric terminal corresponding to the first terminal. When the current adapting and rechargeable device 11 is disposed in the chamber of the portable electronic device 10, the first electric terminal of the rechargeable unit 16 is electrically connected to the second electric terminal of the power connecting module 13.

Since the current adapting and rechargeable device 11 is not electrically connected to any external power source, the current adapting and rechargeable device 11 serves as the power source of the power connecting module 13. When the rechargeable unit 16 has charges, the rechargeable unit 16 provides power to the power connecting module 13. For example, the rechargeable unit 16 outputs a third current C to the power connecting module 13, so that the portable electronic device 10 is powered to operate.

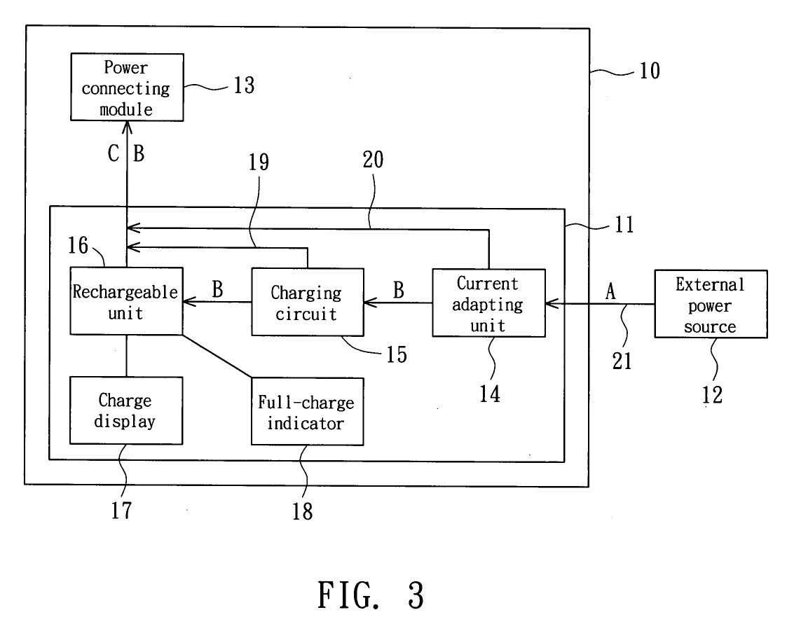

Referring to FIG. 3, a block diagram showing the current adapting and rechargeable device of FIG. 2, which is connected to an external power source, is shown. In FIG. 3, the power connecting module 13 is electrically connected to the external power source 12 via the current adapting and rechargeable device 11. When the charging circuit 15 determines that the charge of the rechargeable unit 16 is not full, the charging circuit 15 utilizes the second current B to charge the rechargeable unit 16.

When the charging circuit 15 determines that the charge of the rechargeable unit 16 is full, the charging circuit 15 does not charge the rechargeable unit 16. Meanwhile, as shown in a first bypass 19, the charging circuit 15 bypasses rechargeable unit 16 along the first bypass 19 to transmit the second current B to the power connecting module 13. In other word, the second current B is transmitted form the charging circuit 15 to the power connecting module 13 and bypasses the rechargeable unit 16. Alternatively, as shown in the second bypass 20, the current adapting unit 14 bypasses the charging circuit 15 and the rechargeable unit 16 along the second bypass 20 to transmit the second current B to the power connecting module 13. In other word, the second current B is transmitted form the current adapting unit 14 to the power connecting module 13 and bypasses the charging circuit 15 and the rechargeable unit 16.

When the power connecting module 13 is electrically connected to the external power source 12 via the current adapting and rechargeable device 11, the charging circuit 15 transmits the second current B to the power connecting module 13 via the rechargeable unit 16 no matter the charging circuit 15 determines that the charge of the rechargeable unit 16 is full or not. That is, the charging circuit 15 transmits the second current B to the power connecting module 13 via the rechargeable unit 16 when the charge of the rechargeable unit 16 is full.

When the charge of the rechargeable unit 16 is not full, the charging circuit 15 utilizes the second current B to charge the rechargeable unit 16 and transmits the second current B to the power connecting module 13 via the rechargeable unit 16.

The current adapting and rechargeable device 11 of the invention can be a battery with adaptor function, an adaptor has battery function, or a portable device with both adaptor and battery function.

The current adapting and rechargeable device disclosed in the above embodiment of the invention has the design of having both adaptor and battery function brings about convenience in terms of portability and use, saving the trouble of bringing an external current adapting unit as a conventional portable electronic device would require of the user. Thus, the problem arising when the user forgets to bring the external current adapting unit with which a flat battery is charged can be avoided. In addition, the current adapting and rechargeable device of the invention can be electrically connected to the external power source via a commonly used power line, and can be electrically connected to the external power source to be charged alone without going with the portable electronic device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A current adapting and rechargeable device, comprising:
a rechargeable unit;
a current adapting unit for receiving a first current from an external power source and outputting a second current accordingly; and
a charging circuit electrically connected to the rechargeable unit and the current adapting unit respectively for receiving and utilizing the second current to charge the rechargeable unit when the charge of the rechargeable unit is not full.

2. The current adapting and rechargeable device according to claim 1, further comprising:
a charge display electrically connected to the rechargeable unit for displaying the charge level of the rechargeable unit.

3. The current adapting and rechargeable device according to claim 1, further comprising:
a full-charge indicator electrically connected to the rechargeable unit for providing a ray of light or a sound when the charging circuit has fully charged the rechargeable unit.

4. The current adapting and rechargeable device according to claim 3, wherein the full-charge indicator is a light bulb, a light emitting diode (LED), a beeper or a speaker.

5. The current adapting and rechargeable device according to claim 1, wherein the charging circuit determines whether the charge of the rechargeable unit is full when the second current is received by the charging circuit;
the charging circuit utilizes the second current to charge the rechargeable unit when the charging circuit determines that the charge of the rechargeable unit is not full; and
the charging circuit does not charge the rechargeable unit when the charging circuit determines that the charge of the rechargeable unit is full.

6. The current adapting and rechargeable device according to claim 5, being disposed in a portable electronic device, wherein the portable electronic device has a power connecting module electrically connected to the rechargeable unit and electrically connected to the external power source via the current adapting and rechargeable device, and the second current is transmitted from the charging circuit to the power connecting module and bypasses the rechargeable unit when the charging circuit determines that the charge of the rechargeable unit is full.

7. The current adapting and rechargeable device according to claim 5, being disposed in a portable electronic device, wherein the portable electronic device has a power connecting module electrically connected to the rechargeable unit and electrically connected to the external power source via the current adapting and rechargeable device, and the second current is transmitted form the current adapting unit to the power connecting module and bypasses the charging circuit and the rechargeable unit when the charging circuit determines that the charge of the rechargeable unit is full.

8. The current adapting and rechargeable device according to claim 5, being disposed in a portable electronic device, wherein the portable electronic device has a power connecting module electrically connected to the rechargeable unit and electrically connected to the external power source via the current adapting and rechargeable device, and the charging circuit transmits the second current to the power connecting module via the rechargeable unit.

9. The current adapting and rechargeable device according to claim 5, being disposed in a portable electronic device, wherein the portable electronic device has a power connecting module electrically connected to the rechargeable unit, and the rechargeable unit provides power to the power connecting module when the current adapting unit does not receive the first current but the rechargeable unit still has charges.

10. The current adapting and rechargeable device according to claim 1, wherein the first current and the second current respectively are an alternating current (AC) and a direct current (DC).

11. A portable electronic device, comprising:
a current adapting and rechargeable device, comprising:
a rechargeable unit;
a current adapting unit for receiving a first current from an external power source and outputting a second current accordingly; and
a charging circuit electrically connected to the rechargeable unit and the current adapting unit respectively for receiving and utilizing the second current to charge the rechargeable unit when the charge of the rechargeable unit is not full; and
a power connecting module electrically connected to the rechargeable unit and electrically connected to the external power source via the current adapting and the rechargeable device.

12. The portable electronic device according to claim 11, wherein the current adapting and rechargeable device further comprises:
a charge display electrically connected to the rechargeable unit for displaying the charge level of the rechargeable unit.

13. The portable electronic device according to claim 11, wherein the current adapting and rechargeable device further comprises:
a full-charge indicator electrically connected to the rechargeable unit for providing a ray of light or a sound when the charging circuit has fully charged the rechargeable unit.

14. The portable electronic device according to claim 13, wherein the full-charge indicator is a light bulb, a light emitting diode (LED), a beeper or a speaker.

15. The portable electronic device according to claim 11, wherein the charging circuit determines whether the charge of the rechargeable unit is full when the second current is received by the charging circuit;
the charging circuit utilizes the second current to charge the rechargeable unit when the charging circuit determines that the charge of the rechargeable unit is not full; and
the charging circuit does not charge the rechargeable unit when the charging circuit determines that the charge of the rechargeable unit is full.

16. The portable electronic device according to claim 15, wherein the second current is transmitted from the charging circuit to the power connecting module and bypasses the rechargeable unit when the charging circuit determines that the charge of the rechargeable unit is full.

17. The portable electronic device according to claim 15, wherein the second current is transmitted form the current adapting unit to the power connecting module and bypasses the charging circuit and the rechargeable unit when the charging circuit determines that the charge of the rechargeable unit is full.

18. The portable electronic device according to claim 15, wherein the charging circuit transmits the second current to the power connecting module via the rechargeable unit.

19. The portable electronic device according to claim 15, wherein the rechargeable unit provides power to the power connecting module when the current adapting unit does not receive the first current but the rechargeable unit still has charges.

20. The portable electronic device according to claim 11, wherein the first current and the second current respectively are an alternating current (AC) and a direct current (DC).
